(19) United States
(12) Patent Application Publication
(10) Pub. No.: US 2016/0077212 A1
(43) Pub. Date: Mar. 17, 2016

(54) TRACKING BUOY

(71) Applicant: WORLEYPARSONS SERVICES PTY LTD, North Sydney, New South Wales (AU)

(72) Inventors: Benjamin Nathan HUNT, Perth, Western Australia (AU); Matthew Zed, Perth, Western Australia (AU); Peter Mellor, Perth, Western Australia (AU); David Ryan, Perth, Western Australia (AU); Jesse Shakespeare, Perth, Western Australia (AU); Kloe Hunt, Perth, Western Australia (AU)

(21) Appl. No.: 14/783,473

(22) PCT Filed: Apr. 11, 2014
(86) PCT No.: PCT/AU2014/000407

§ 371 Date: Oct. 9, 2015

(30) Foreign Application Priority Data
Apr. 11, 2013 (AU) 2013204076

(51) Int. Cl. G01S 19/14; B63B 22/24; B63B 22/20

(52) U.S. Cl. CPC G01S 19/14; B63B 22/20; B63B 22/24; B63B 2213/02

(57) ABSTRACT

A tracking buoy (10), comprising: a body portion (12); and a GPS tracking unit (14); wherein the GPS tracking unit (14) is removably contained on or within the body portion (12), and the mass of the tracking buoy (10) being such that less than about 100 mm of the tracking buoy (10) projects above the waterline during operation.

### TECHNICAL FIELD

The present invention relates to a tracking buoy. More specifically, the present invention relates to a tracking buoy intended to be suitable for use in tracking the motion of aquatic oil spills.

### BACKGROUND ART

The following discussion of the background art is intended to facilitate an understanding of the present invention only. The discussion is not an acknowledgement or admission that any of the material referred to is or was part of the common general knowledge as at the priority date of the application.

An oil spill is the release of a liquid petroleum hydrocarbon into the environment. When such a spill occurs in a marine environment it can cause massive ecological damage. Cleanup and recovery from an oil spill is known to be particularly difficult and depends upon many factors, including the type of oil spilled, the temperature of the water and the size of area that is affected. Depending upon these factors, spills may take weeks, months or even years to clean up.

An important factor in the clean up of such an oil spill or slick is the tracking of the movement of the spill so that preventative and containment measures can be put in place. One method of tracking the oil slick is through the use of GPS tracking buoys. Such buoys are placed in the affected area in the expectation that they move with the surface currents of the oil spill, providing real time data regarding the oil slick's movement.

Conventional GPS buoys however have been found not to accurately track the movement of the surface current. This is thought to be due to a number of factors. As discussed in Oil Spill Science and Technology, Ed. Fingas Mervin, Gulf Professional Publishing, 2010, “Oil drifts with the surface current at 100% of the current speed, but only a fraction of the wind speed with it commonly accepted that wind drift accounts for 1 to 6% (typically 3%) of the ultimate trajectory”. Accordingly, the movement of an oil slick is only impacted by the wind speed and direction above the slick to a small extent. However, conventional GPS tracking buoys typically have 50% of their volume extending above the water line. When coupled with the plethora of antennas and vane structures that are often positioned on the top of such buoys, this presents a large area to be caught by the wind, potentially causing the trajectory of the buoy to deviate away from the oil spill's trajectory.

The act of deployment of conventional buoys into oil spills also represents a significant problem. Given the fragility of the instruments that are contained within and on the buoy, deployment of such buoys must occur close to the water line, thus making it impossible to deploy such devices from the height of a rig platform or a helicopter. During an oil spill, the requirement for deployment close to the water line represents an obvious health and safety issue.

The present invention seeks to overcome, or at least ameliorate, one or more of the deficiencies of the prior art mentioned above, or to provide the consumer with a useful or commercial choice. Particularly, the present invention seeks to provide a tracking buoy which will accurately track an oil spill and/or is sufficiently robust to withstand deployment from a significant height above the water.

Each document, reference, patent application or patent cited in this text is expressly incorporated herein in their entirety by reference, which means that it should be read and considered by the reader as part of this text. That the document, reference, patent application or patent cited in this text is not repeated in this text is merely for reasons of conciseness.

Throughout this specification, unless the context requires otherwise, the term “GPS tracking unit”, will be understood to imply a device that uses the Global Positioning System to determine the precise location of a vehicle, person, or other asset to which it is attached and transmit this data to a central location data base, or internet-connected computer, by way of a cellular (GPRS or SMS), radio, or satellite modem embedded in the unit.

Throughout this specification, unless the context requires otherwise, the term “GPS tracking software”, will be understood to imply any software which allows the location of the GPS tracking unit to be displayed against a map backdrop either in real time or when analyzing the recorded data later. This is also understood to include software provided over web interfaces, which allows a user to obtain real time positioning data on a computer or smartphone.

Throughout this specification, unless the context requires otherwise, the word “comprise” or variations such as “comprises” or “comprising”, will be understood to imply the inclusion of a stated integer or group of integers but not the exclusion of any other integer or group of integers.

### SUMMARY OF INVENTION

In accordance with the present invention, there is provided a tracking buoy, comprising:
a body portion; and
a GPS tracking unit,
   wherein the GPS tracking unit is removably contained on or within the body portion, and the mass of the tracking buoy being such that less than about 100 mm of the tracking buoy projects above a waterline during operation.

Preferably, the mass of the tracking buoy is such that less than about 50 mm of the tracking buoy projects above the waterline during operation. More preferably, the mass of the tracking buoy is such that less than about 20 mm of the tracking buoy projects above the waterline during operation. Still preferably the mass of the tracking buoy is such that less than about 10 mm of the tracking buoy projects above the waterline during operation.

In one form of the present invention, the body portion is provided in the form of a truncated cone. Preferably, the body portion further comprises a hollow section. More preferably, the body portion is provided with a first end having a closed decreased diameter and a second end having an open larger diameter.

In one form of the present invention, the buoy of the present invention further comprises a ballast means provided in or on the underside of the body portion. Preferably, the ballast means is provided in the form of a ballast weight releasably fastened to the body. Still preferably, the ballast weight is constructed of lead.

In a highly preferred from of the present invention, the ballast weight is provided at the first end of the body portion. Preferably, the hollow section and the ballast weight is arranged such that centre of mass of the tracking buoy is below the centre of buoyancy of the tracking buoy.

In one form of the present invention, the tracking buoy further comprises a lid, whereby the GPS tracking unit is sealed inside the body portion.

In one form of the present invention, the GPS tracking unit is seated on a mounting plate which extends across the hollowed section of the body portion. Still preferably, the GPS tracking unit is seated in a base which is adapted to receive the GPS tracking unit and which is in turn seated on the mounting plate. In a highly preferred form of the present invention, an underside of the lid is also provided with one or more cavities in which the GPS tracking unit in which the GPS tracking unit may be received and whereby the GPS tracking unit may be positively located.

In one form of the present invention the tracking buoy further comprises a switch for operating the GPS tracking unit. Preferably the switch may be accessed through a sealable aperture in the lid. Such an aperture allows for the GPS tracking unit to be easily switched on and off by an operator without the need to remove the lid from the body portion. Still preferably, the sealable aperture is sealed by way of a plug.

In one form of the present invention, the lid is fastened to the body portion by a plurality of fastening means positioned around the perimeter of the lid. Still preferably, the fastening means are screws.

In one form of the present invention a sealing means is provided between the lid and the body portion. Preferably, the sealing means comprises one or more O-ring seals. More preferably, the body portion and the lid further comprise one or more channels in their surfaces in order to accommodate the one or more O-ring seals.

In one form of the present invention, the hollow section of the body portion has an amount of lightweight plastic foam, such as polystyrene, provided therein in order to reduce the volume thereof.

Preferably, the body portion and the lid are constructed of high density polyurethane.

The GPS tracking unit is provided in the form a single self-contained unit, which requires no external power supply or antenna. Preferably, the GPS tracking unit is satellite-managed unit. Still preferably, the real time position of the GPS tracking unit can be visualised by way of GPS tracking software.

In one form of the present invention the ballast means is provided in the form of a balance.

Preferably, the balance is provided on the underside of the body portion. More preferably, the balance is provided in the form of a balancing weight positioned distal to the body portion by way of elongate balance body portion. Still preferably, the balance weight and the elongate balance body portion are integrally formed.

In one form of the present invention, the balance weight is shaped such that three or more equilaterally spaced vanes extend therefrom. Preferably, these vanes are constructed form the same material as the balance weight and are integrally formed therewith. Still preferably, there are four vanes provided on the balance weight.

In accordance with a further embodiment of the present invention, there is provided a tracking buoy, comprising:
a body portion provided in the form of a hollow truncated cone;
a ballast means releasably fastened to an underside of the body portion; and
a GPS tracking unit;
   wherein the GPS tracking unit is removably contained within the body portion, and wherein the ballast means is provided in the form of weight and the mass of the tracking buoy being such that less than about 100 mm of the tracking buoy projects above the waterline during operation.

In accordance with still further embodiment of the present invention, there is provided a tracking buoy, comprising:
a body portion provided in the form of a hollow truncated cone;
a ballast means releasably fastened to an underside of the body portion; and
a GPS tracking unit;
   wherein the GPS tracking unit is removably contained within the body portion, and wherein the ballast means is provided in the form of a balancing weight positioned distal to the body portion by way of elongate balance body portion and the mass of the tracking buoy being such that less than about 100 mm of the tracking buoy projects above the waterline during operation.

### BRIEF DESCRIPTION OF THE DRAWINGS

Further features of the present invention are more fully described in the following description of two non-limiting embodiments thereof. This description is included solely for the purposes of exemplifying the present invention. It should not be understood as a restriction on the broad summary, disclosure or description of the invention as set out above. The description will be made with reference to the accompanying drawings in which:

FIG. 1 is a cross-sectional view of a tracking buoy of the present invention;

FIG. 2 is an upper perspective view of the tracking buoy of FIG. 1;

FIG. 3 is side view of the tracking buoy of FIG. 1 in use in an oil spill;

FIG. 4 is a cross-sectional view of a tracking buoy in accordance with a second embodiment of the tracking buoy of the present invention; and

FIG. 5 is an upper perspective view of the tracking buoy of FIG. 4.

### DESCRIPTION OF EMBODIMENTS

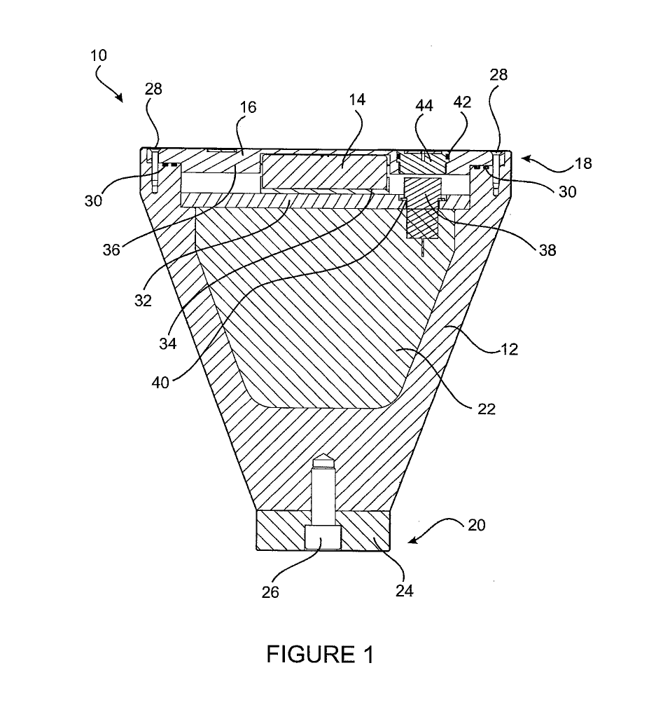

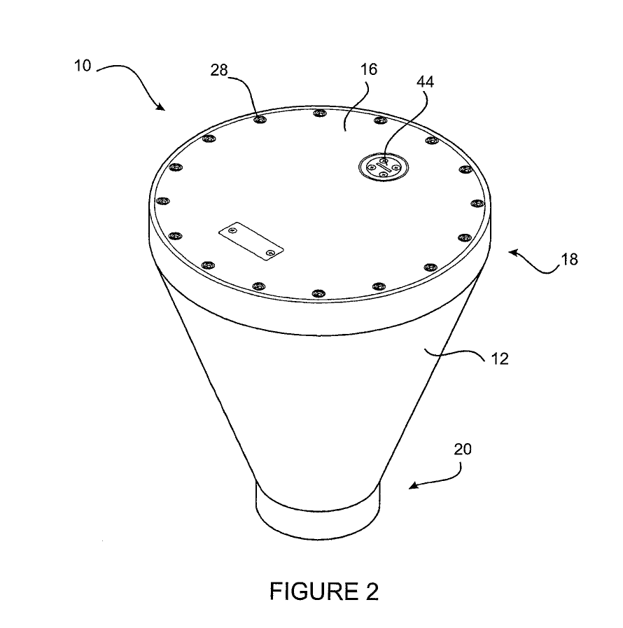

In FIGS. 1 to 3 there is shown a tracking buoy 10 in accordance with the present invention. The tracking buoy 10 comprises a truncated conical body portion 12, a GPS tracking unit 14 and a lid 16. The truncated conical body portion 12 has a first end 18 having a large diameter, and a second end 20 having a small diameter. Provided within the truncated conical body portion 12 there is a hollow section 22. At the second end 20 there is provided a ballast means, for example a ballast weight 24 which is secured to the second end 20 by way of a fastening bolt or screw 26. The ballast weight 24 may be formed of lead, for example.

The lid 16 is secured to the body portion 12, by was a fastening screws 28. Concentric seals 30 are provided within channels that run around the hollow section 22 of the body portion 12, such that the tracking buoy 10 remains watertight.

Extending across the hollow section is a mounting plate 32. Seated on the mounting plate 32 is a GPS base 34, which is adapted to receive and secure the GPS tracking unit 14. As can be best seen in FIG. 1, the lid provided with features 36 which aid in the retention of the GPS tracking unit 14.

Coupled with the GPS tracking unit 14 is a switch 38 which is used to switch the GPS tracking unit 14 between an operation condition and a non-operating condition. The switch 14 is retained in a switch mounting plate 40 which is recessed into the mounting plate 32. Provided in the lid 16 is an aperture 42, which allows access to the switch 38. A removable plug 44 is used to seal the aperture 42 during use.

The hollow section 22 is filled with polystyrene in order to reduce the volume that water can occupy in the event of a leak.

The GPS tracking unit 14 is provided in the form a single self-contained unit, which requires no external power supply or antenna. Preferably, the GPS tracking unit is a commercially available tracker, such as the SmartOne LP produced by GlobalStar, Inc.

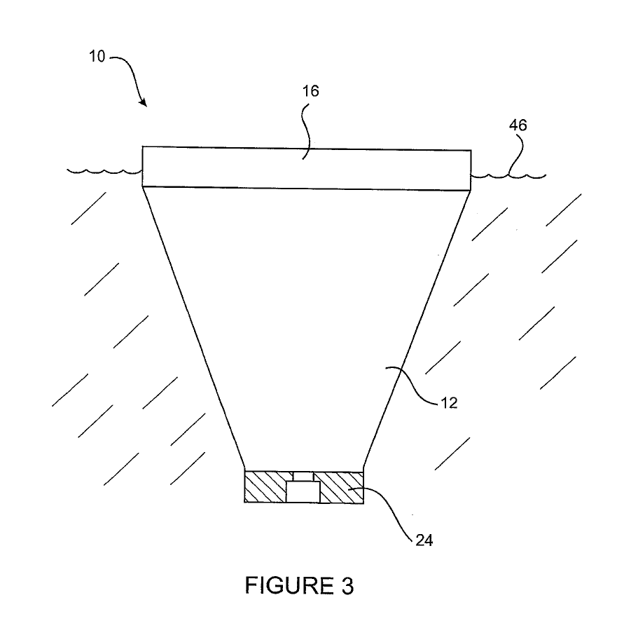

As can be seen in FIG. 3, in use, the tracking buoy 10 will be suspended in a body of water 46 such that less than about 50 mm, for example less than about 20 mm and preferably less than about 10 mm of the body portion 12 is above the waterline. The height above the waterline is determined by the mass of all the components of the tracking buoy 10 relative to the buoyancy force exhibited by the water. Should the tracking buoy of the present invention float too low or high in the water, the size of the ballast weight can be decreased or increased in order to correct the height.

Through the use of a simple web interface, the location of the tracking buoy 10 of the present invention can be monitored by way of the GPS tracking unit. Thus enabling real time positioning data to be provided to oil spill response teams.

By providing a buoy that only has a small percentage of its total volume above the water, and that does not require any additional antennas or other instruments that extend from the top of the unit, the tracking buoy 10 of the present invention is less affected by the wind speed than previous buoys. In this manner the movement of an oil spill may be more accurately tracked.

Additionally, by providing the GPS tracking unit 14 securely within the robust body of the buoy, the tracking buoy 10 of the present invention may be deployed from a height of approximately 50 m above the waterline. This enables the apparatus to be deployed from the side of an oil rig or by a helicopter over the water.

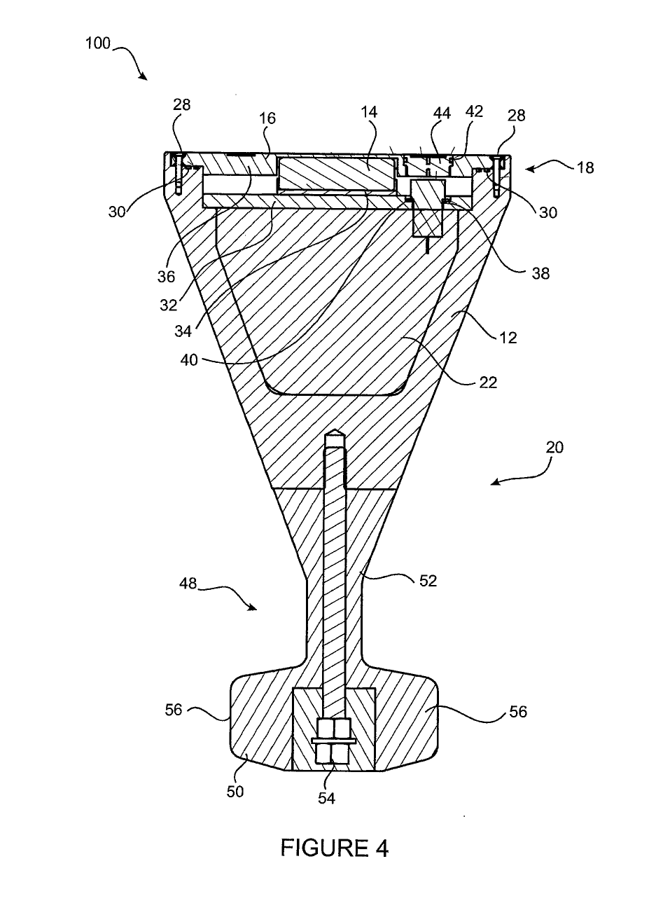

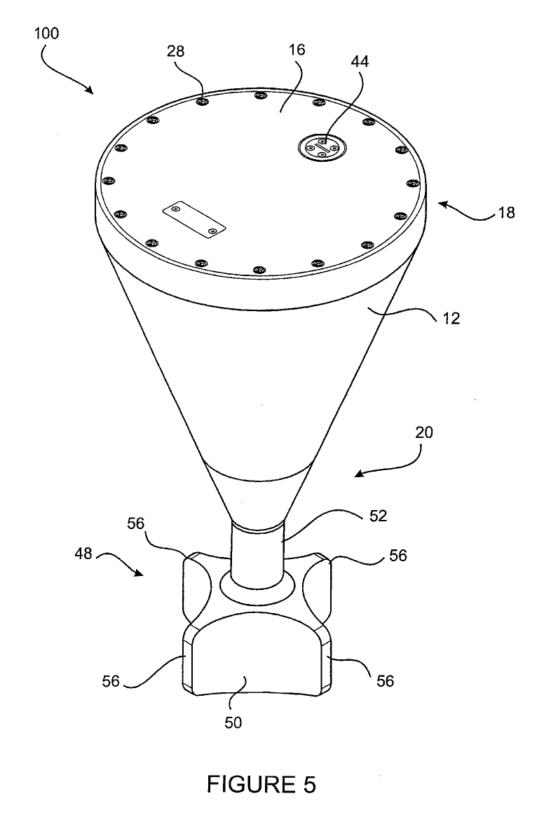

In FIGS. 4 and 5 there is shown a tracking buoy 100 in accordance with a second embodiment of the present invention and like numerals denote like features. The tracking buoy 100 has fastened to the second end 20 a ballast means in the form of a balance 48. The balance 48 comprises a balancing weight 50 and an elongate balance body portion 52. The balancing weight 50 and the elongate balance body portion 52 are arranged such that the balancing weight 50 is spaced apart from, or distal, with respect to the body portion 12 by way of the elongate balance body portion 52. Importantly, the length of the balance is such that the tracking buoy 100 is contained within only the top 0.5 m of the water body in which it is deployed.

The balance weight 48 is fastened to the body portion by way of a bolt 54 which extends through the balance 48 and into the body portion 12. In such a manner the balance may be removed from the body portion 12.

The balance weight 50 has four vanes 56 extending radially therefrom in an equilateral spacing. The vanes 56 are formed of the same material as the weight 50 and are integrally formed therewith.

In particularly rough seas conditions, the buoy 100 may be rocked by the waves to an extent that the signal transmitted by the buoy 100 is interrupted. By providing the balance 48 of the second embodiment, the stability of the buoy 100 is increased, resulting in improved signal broadcast. The vanes 56 act to further stabilise the buoy 100 when in the water.

Those skilled in the art will appreciate that the invention described herein is susceptible to variations and modifications other than those specifically described. The invention includes all such variation and modifications. The invention also includes all of the steps, features, formulations and compounds referred to or indicated in the specification, individually or collectively and any and all combinations or any two or more of the steps or features.

1. In accordance with the present invention, there is provided a tracking buoy, comprising:
a body portion; and
a GPS tracking unit,
wherein the GPS tracking unit is removably contained on or within the body portion, and the mass of the tracking buoy being such that less than about 100 mm of the tracking buoy projects above a waterline during operation.

2. A tracking buoy according to claim 1, wherein the mass of the tracking buoy is such that less than about 50 mm of the tracking buoy projects above the waterline during operation.

3. A tracking buoy according to claim 1, wherein the mass of the tracking buoy is such that less than about 20 mm of the tracking buoy projects above the waterline during operation.

4. A tracking buoy according to claim 1, wherein the mass of the tracking buoy is such that less than about 10 mm of the tracking buoy projects above the waterline during operation.

5. A tracking buoy according to claim 1, wherein the body portion is provided in the form of a truncated cone.

6. A tracking buoy according to claim 1, wherein the body portion further comprises a hollow section.

7. A tracking buoy according to claim 5, wherein body portion is provided with a first end having a closed decreased diameter and a second end having an open larger diameter.

8. A tracking buoy according to claim 1, wherein the buoy further comprises a ballast means provided in or on the underside of the body portion.

9. A tracking buoy according to claim 8, wherein the ballast means is provided in the form of a weight releasably fastened to the body portion.

10. A tracking buoy according to claim 8, wherein the ballast means is constructed of lead.

11. A tracking buoy according to claim 8, wherein the ballast means is provided at the first end of the body portion.

12. A tracking buoy according to claim 8, wherein the hollowed section and the ballast means are arranged such that centre of mass of the tracking buoy is below the centre of buoyancy of the tracking buoy.

13. A tracking buoy according to claim 1, wherein the tracking buoy further comprises a lid, whereby the GPS tracking unit is sealed inside the body portion.

14. A tracking buoy according to claim 1, wherein the GPS tracking unit is seated on a mounting plate which extends across the hollowed section of the body portion.

15. A tracking buoy according to claim 14, wherein the GPS tracking unit is seated in a base which is adapted to receive the GPS tracking unit and which is in turn seated on the mounting plate.

16. A tracking buoy according to claim 13, wherein an underside of the lid is also provided with one or more cavities in which the GPS tracking unit in which the GPS tracking unit may be received and whereby the GPS tracker may be positively located.

17. A tracking buoy according to claim 1, wherein the tracking buoy further comprises a switch for operating the GPS tracking unit.

18. A tracking buoy according to claim 17, wherein the switch may be accessed through a sealable aperture in the lid.

19. A tracking buoy according to claim 18, wherein the sealable aperture is sealed by way of a plug.

20. A tracking buoy according to claim 1, wherein the lid is fastened to the body portion by a plurality of fastening means positioned around the perimeter of the lid.

21. A tracking buoy according to claim 20, wherein the fastening means are screws.

22. A tracking buoy according to claim 1, wherein a sealing means is provided between the lid and the body portion.

23. A tracking buoy according to claim 22, wherein the sealing means comprises one or more O-ring seals.

24. A tracking buoy according to claim 23, wherein the body portion and the lid further comprise one or more channels in their surfaces in order to accommodate the one or more O-ring seals.

25. A tracking buoy according to claim 6, wherein the hollow section of the body portion has an amount of lightweight plastic foam, such as polystyrene, provided therein in order to reduce the volume thereof.

26. A tracking buoy according to claim 1, wherein the body portion and the lid are constructed of high density polyurethane.

27. A tracking buoy according to claim 1, wherein GPS tracking unit is provided in the form a single self-contained unit, which requires no external power supply or antenna.

28. A tracking buoy according to claim 27, wherein the GPS tracking unit is satellite-managed unit.

29. A tracking buoy according to claim 26, wherein the real time position of the GPS tracking unit can be visualised by way of GPS tracking software.

30. A tracking buoy according to claim 8, wherein the ballast means is provided in the form of a balance.

31. A tracking buoy according to claim 30, wherein the balance is provided on the underside of the body portion.

32. A tracking buoy according to claim 30, wherein the balance is provided in the form of a balancing weight positioned distal to the body portion by way of elongate balance body portion.

33. A tracking buoy according to claim 32, wherein the balance weight and the elongate balance body portion are integrally formed.

34. A tracking buoy according to claim 32, wherein the balance weight is shaped such that three or more equilaterally spaced vanes extend therefrom.

35. A tracking buoy according to claim 34, wherein these vanes are constructed form the same material as the balance weight and are integrally formed therewith.

36. A tracking buoy according to claim 34 wherein there are four vanes provided on the balance weight.

37. A tracking buoy, comprising:
a body portion provided in the form of a hollow truncated cone;
a ballast means releasably fastened to an underside of the body portion; and
a GPS tracking unit;
wherein the GPS tracking unit is removably contained within the body portion, and wherein the ballast means is provided in the form of weight and the mass of the tracking buoy being such that less than about 100 mm of the tracking buoy projects above the waterline during operation.

38. A tracking buoy, comprising:
a body portion provided in the form of a hollow truncated cone;
a ballast means releasably fastened to an underside of the body portion; and
a GPS tracking unit;
wherein the GPS tracking unit is removably contained within the body portion, and wherein the ballast means is provided in the form of a balancing weight positioned distal to the body portion by way of elongate balance body portion and the mass of the tracking buoy being such that less than about 100 mm of the tracking buoy projects above the waterline during operation.
